(19) United States
(12) Patent Application Publication
(10) Pub. No.: US 2007/0287142 A1
(43) Pub. Date: Dec. 13, 2007

(54) Educational device

(76) Inventor: Charles Truax, New York, NY (US)

Correspondence Address: COWAN LIEBOWITZ & LATMAN P.C, 1133 AVENUE OF THE AMERICAS, 1133 AVENUE OF THE AMERICAS, NEW YORK, NY, 10036, US

(21) Appl. No.: 11/374,313

(22) Filed: Jun. 7, 2006

(51) Int. Cl. G09B 25/00

(52) U.S. Cl. 434/419

(57) ABSTRACT

An educational device comprising a housing and combined rotational device for offering a collective display of information to provide the user one or more instructional lessons. The device comprises a construction within the housing which promotes added rigidity to thereby promote extended product life and ease in handling thereof.

### BACKGROUND OF THE INVENTION

This invention relates to educational devices, and in particular, to such types of devices which convey varied information in response to a user's manipulation thereof.

All sorts of educational devices are used throughout society. Often, these devices use a chart-like configuration as the way in which to present a particular category of information. This type of configuration allows a user to obtain a display of one or more categories of information at a given time. Consequently, there exists the opportunity for multi-dimensional learning.

It has been observed that past designs of devices using the chart-like configuration have, many times, been formed of a construction that is weak in regard to the ability to withstand repeated use and/or less than desirable handling. Each of these conditions decreases the overall durability of the device which frequently leads to a decreased opportunity for its use and increased need for repeated purchase.

Accordingly, it would be desirable to provide an educational device comprising a construction which is both sturdy and able to display information on multiple surfaces thereof.

### SUMMARY OF THE INVENTION

In accordance with the embodiment(s) of the invention disclosed hereinafter, the above desire is fulfilled by an educational device conveying information on multiple surfaces thereof, portions of which may be read in conjunction with other information made available and variable through use of a user actuated component.

The educational device herein comprises information that is imprinted on its several surfaces, thereby affording an opportunity for continued reference. Still further information may be provided to the user through use of a rotatable wheel comprising various information imprinted thereon which may be viewed through openings provided in the housing, and which is coordinable with information imprinted on the housing. Coordination of these two sets of information affords the user the opportunity to read that information collectively to obtain an instructional lesson to increase the user's overall knowledge on a given topic.

To enable its extended use, and thus its teaching capability, the device is constructed using a housing and core member contained therewithin. The core member imparts a rigidity and desired depth to the housing overall. These attributes allow the device to be easily handled without the concerns attending constructions of lesser strength. Moreover, the depth provided by the core member allows for the imprinting of information on an exterior surface of the housing which is of a size that is visible and readable from a distance. Together with its sturdy construction, this feature allows the device to be shelved in the same manner as a book and thereafter easily identified to enable proper selection before reading.

Additionally, it is conceivable and contemplated to easily group several devices each of which concerns a given subject on a particular topic such as, for example, the types of trees in a given geographical region or the numerous varieties of wine, etc. Once grouped, the devices can be stocked according to the given topic and subject as if they were collections of books.

Accordingly, there is provided an educational device comprising a construction that allows for the reliable, extended and convenient use thereof.

### BRIEF DESCRIPTION OF THE DRAWINGS

FIG. 1 is a side and perspective view of the educational device according to the invention disclosed herein.

FIG. 2 is a perspective view illustrating the construction of the device according to FIG. 1.

FIG. 3 is a perspective view illustrating a rotatable member of the device according to FIG. 1.

FIG. 4 is a perspective view illustrating a stationary member of the device according to FIG. 1.

FIG. 5 is an exploded view illustrating the construction of the device according to FIG. 1.

FIG. 6 is a perspective view illustrating a further embodiment of an educational device as described herein.

### DETAILED DESCRIPTION OF THE DRAWINGS

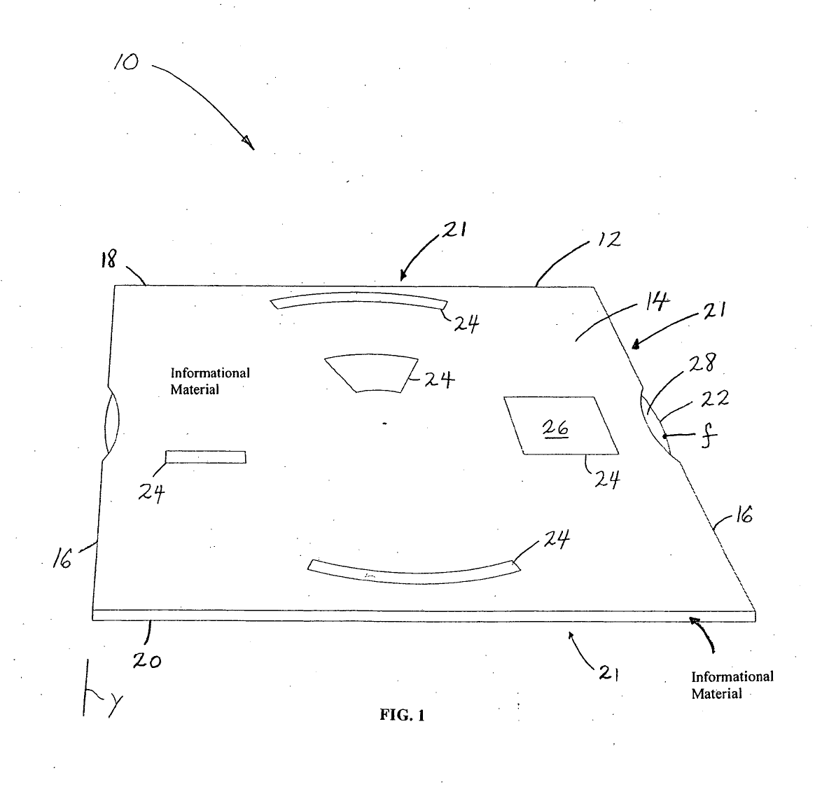

Looking to FIG. 1, there is shown an educational device 10. The device 10 comprises a housing 12 of depth “d”, and which is optionally constructed of weighted paper such as cardboard. As may be seen therein, the housing 12 comprises a plurality of surfaces comprising front, side and back surfaces 14, 16, 18 and 20, respectively. Side surfaces 16 and 18 define a spine 21 of the device 10 along which it is contemplated that informational material be imprinted. Along such side surfaces 16, which define the spine 21 of the device 10, it can be seen that a wafer member, optionally constructed as a rotatable wheel 22 of similar material as is used in the construction of the housing 12, protrudes from the spine to an axis “Y” parallel to each of the side surfaces 16. As may also be seen with reference to FIG. 1, the front surface 14 of the housing 12 comprises a plurality of openings 24 through which portions 26 of a top surface 28 of the wheel 22 may be viewed.

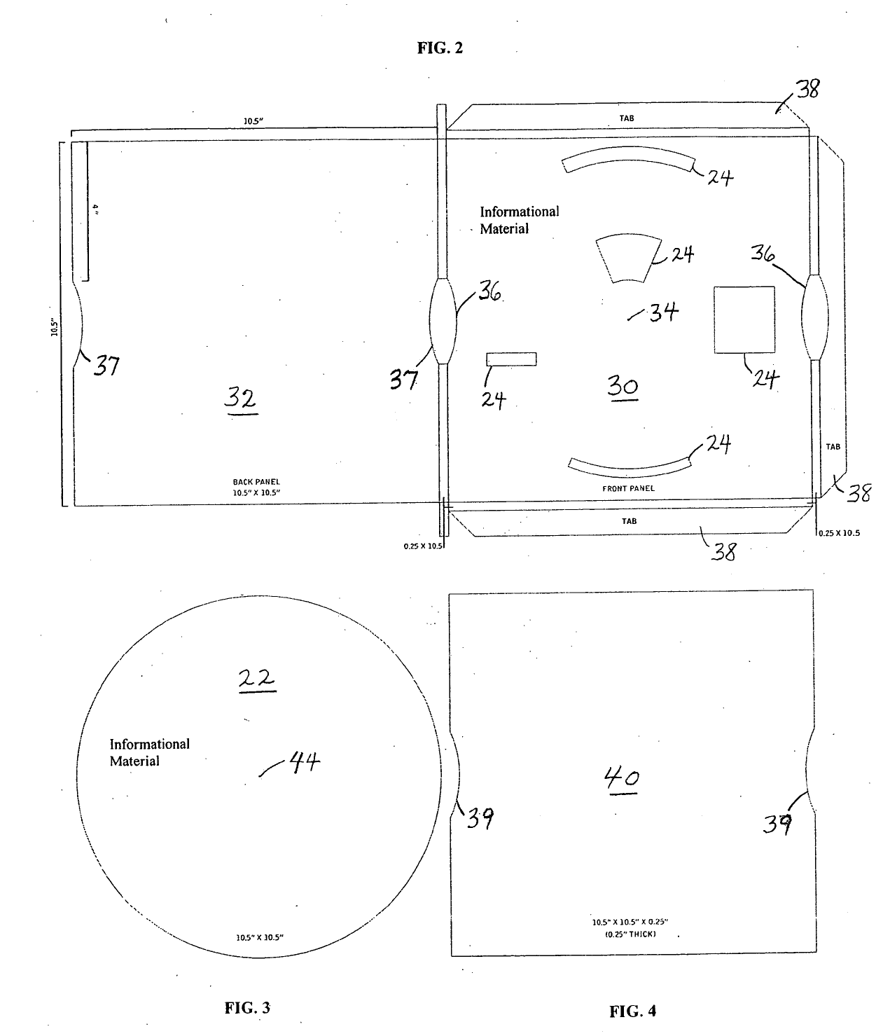

Looking to FIGS. 2-4, there is shown more closely the separate members comprising the device 10. With reference first to FIG. 2, it may be understood that it is contemplated that the housing 12 comprise a front surface panel 30 and a back surface panel 32, with the front surface panel 30 comprising the already mentioned openings 24. Front surface panel 30 further comprises a pinhole-like opening 34 approximately at the center thereof. Each of the panels 30 and 32 comprise matching arcuate cutouts 36 and 37, respectively. Tabs 38 extend from the front surface panel 30.

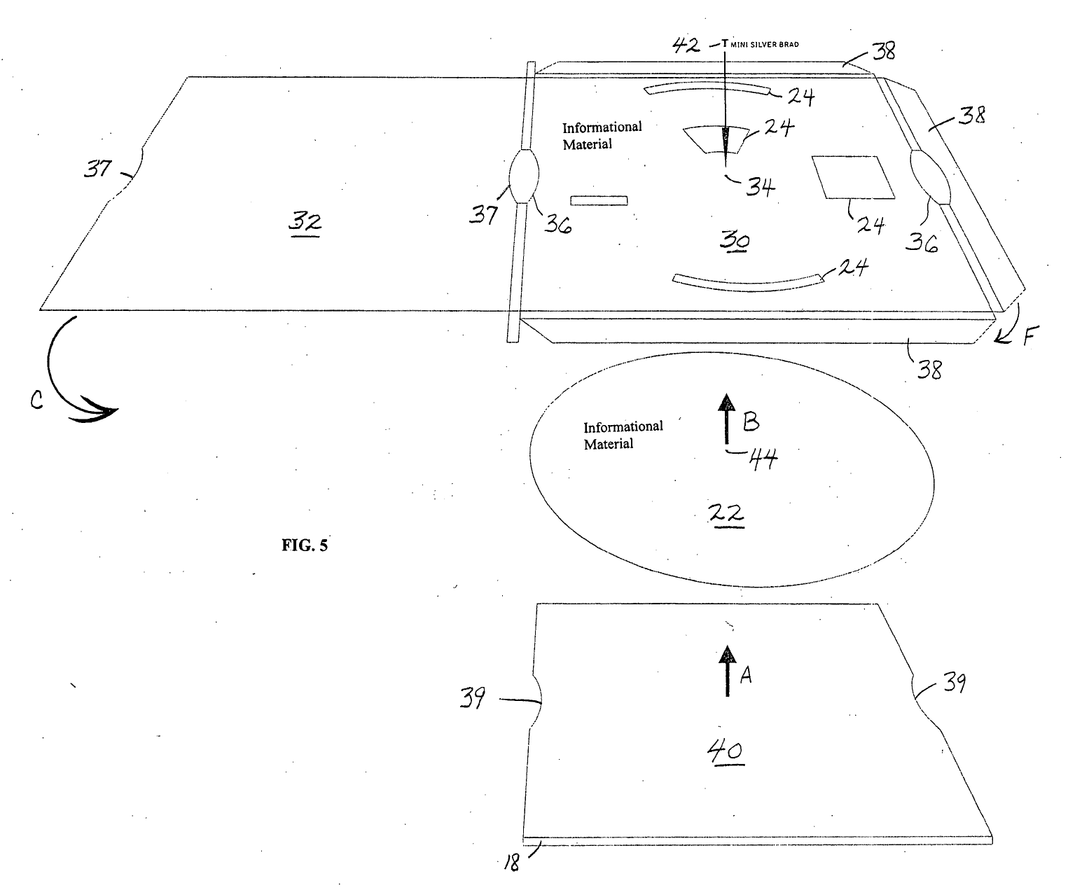

With reference to FIG. 3, there is shown the wheel 22. As may be seen with reference to both FIGS. 1 and 3, it may be understood that the wheel 22 comprises a diameter which is comparable to the width of the housing 12 as shown in FIG. 1. Looking to FIG. 4, there is shown a core member 40 of the device 10. The core member 40 is, optionally, constructed of a foam material in order to decrease the overall weight of the device 10, thereby further contributing to ease in handling. It is contemplated that the core member 40 also be constructed of other such materials as paper, lightweight plastic or a composite of variously chosen materials.

Looking to FIG. 5, the contemplated assembly of the components shown throughout FIGS. 2-4 is provided. Therein, it can be understood that the device 10 is constructed so that the core member 40 serves as a base for the wheel 22, as indicated by arrow “A”, and that the combination thereof is then abutted against the underside of surface 14 of the front surface panel 40 which is opposite that shown in FIG. 5, as indicated by arrow “B”. Once this is accomplished, the back surface panel 32 is moved toward and under the core member 40, as is indicated by arrow “C”. Thereafter, each of the components discussed hereinabove and the back surface panel 32 are secured in place by folding over and affixing, for example by adhesive, side surface extending tabs 38 onto the back surface panel 32, see arrow “F”. A pin-like element 42 is then inserted through holes 34, 44 contained in each of the front surface panel 30 and the wheel 22, respectively, to allow the wheel 22 to spin thereabout, and on and against the core member 40.

It is contemplated that each of the wheel 22 and the front surface panel 30 contain informational material that is coordinable in such a manner so as to convey multiple instructional lessons to a user. For instance, it is contemplated that a user grasp the wheel 22 at “f”, as shown in FIG. 1, and rotate it to move informational material contained thereon into alignment with one of the openings 24. Thereafter, informational material contained thereon can be viewed together with that which is imprinted on the front surface panel 30. As may be seen in FIG. 5, core member 40 includes arcuate cutouts 39 which are similarly shaped to those of the front and back surface panels 30 and 32 so as to allow a user enough space to comfortably access and rotate the wheel 22.

“Attachment “D”, containing pages numbered 1 through 16, is hereby incorporated by reference in its entirety for the exemplary purpose of providing the reader additional explanation of and reference to the educational device discussed hereinthroughout. The materials provided in “Attachment D” are not intended to be limiting in any way in regard to the description provided herein.

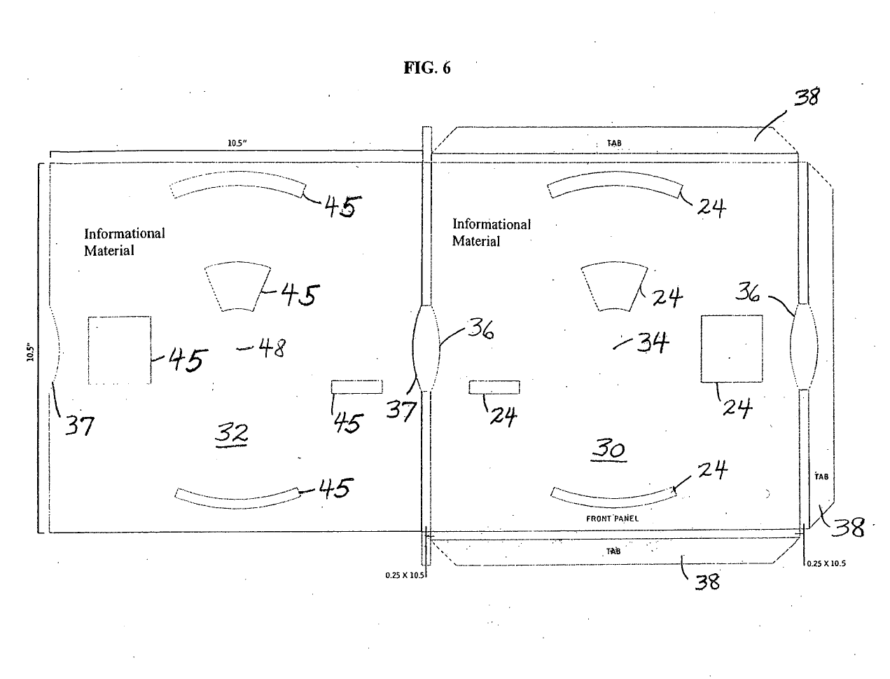

While the above construction has been described in detail, it is to be understood that it is also contemplated to provide an educational device having the following modifications thereto. For illustrative purposes, similar reference numerals designate similar elements as in FIGS. 1-6. It is contemplated that the back surface panel 32 also contain informational material that the reader may reference when using the device 10. Also, it is contemplated that each of the front and back surface panels 30, 32 contain similarly placed openings 24, 45, respectively, as may be seen with reference to FIG. 6.

In any of the constructions described hereinthroughout, or in a separate construction, it is also contemplated that notwithstanding the areas on which informational material is provided, that the depth “d” of the housing 12 be achieved in the following two additional ways. First, it is contemplated that the core member 40 be sandwiched between two similar wheels 22 so as to achieve a construction therewithin the housing 12 and of a depth which is substantially equivalent to, but slightly less than the depth “d”. Back surface panel 32 further comprises a pinhole-like opening 48 similar to opening 34 of the front surface panel to accommodate, when necessary, pin-like element 42 or further element similar thereto. Second, it is contemplated that the core member 40 not comprise any part of the construction of the device 10 and that the wheel 22 be constructed of such thickness, substantially equivalent to, but slightly less than depth “d”of the housing 12, so as to thereby represent the thickness of the core member 40. In each of these constructions, whether a dual or single wheel construction is used, it is contemplated that the particular wheel or wheels used comprise informational material printed on those wheel surfaces which are viewable through the openings 24, 45. In other words, it is contemplated that the dual-wheel construction comprise informational material on each surface of each wheel that is viewable through the openings 24, 45; and that the single wheel construction comprise information material on both sides of the wheel so as to allow the conveying of multiple instructional lessons to the user. Accordingly, and in sum, the above further constructions comprising a pair of wheels 22 and single core member 40 or a single wheel 22 each comprise a depth commensurate with their description as referenced above in order to permit their functionality, but while still imparting a rigidity to the overall device construction that is akin to that provided by the construction of the device 10 in which a single wheel 22 and core member 40 are present.

It is also contemplated that the educational device 10 as described hereinthroughout may also be amendable to shelving in a display arrangement which is receptive to its dimensions and ability to convey information.

Accordingly, there is provided an educational device conveying information on multiple surfaces thereof, portions of which may be read in conjunction with other information made available and variable through use of a user actuated component in order to convey multiple instructional lessons.

In all cases it is to be understood that the above-described subject matter is merely illustrative of the may possible specific embodiments, which represent applications of the present invention. Numerous and varied other arrangements can be readily devised in accordance with the principles of the present invention, without departing from the spirit and scope of the invention.

I claim:

1. An educational device, comprising:
a) a housing comprising a plurality of surfaces and several openings therethroughout, at least one of such plurality comprising informational material arranged relative to the several openings;
b) a core member within the housing, the core member imparting a depth to the housing; and
c) a wafer comprising a plurality of informational material, the wafer being positioned with the core member therewithin the housing to permit viewing of such informational material through one or more of the openings, thereby permitting a collective reading of any one of the plurality of informational material thereon together with the informational material of the at least one of the plurality of surfaces of the housing, such collective reading providing an instructional lesson to the user.

2. The educational device as recited in claim 1, wherein:
the wafer is associated with the core member to permit rotation thereupon, such rotation positioning another of the plurality of informational material thereon relative to that of the at least one of the plurality of surfaces of the housing to enable a further collective reading of such informational material so as to permit a further associated instructional lesson to the user.

3. The educational device as recited in claim 2, wherein:
each of the core member and the housing comprise matching arcuate surfaces therealong, the wafer extending beyond the arcuate surfaces and to an axis parallel with a surface of the housing so as to enable a user to actuate rotation of the wafer.

4. The educational device as recited in claim 1, wherein:
each of the core member and the housing comprise matching arcuate surfaces therealong, the wafer extending beyond the arcuate surfaces and to an axis parallel with a surface of the housing so as to enable a user to actuate rotation of the wafer.

5. An educational device, comprising:
a) a housing defining a depth thereof and comprising a plurality of surfaces and several openings therethroughout, at least one of such plurality comprising informational material arranged relative to the several openings; and
b) a wafer comprising a thickness substantially equivalent to the depth of the housing, and further comprising a plurality of informational material thereon, the wafer being positioned within the housing to permit movement therewithin to accomplish viewing of informational material contained thereon through one or more of the openings, thereby permitting a collective reading of any one of the plurality of informational material thereon together with the informational material of the at least one of the plurality of surfaces of the housing, such collective reading providing an instructional lesson to the user.

6. An educational device, comprising:
a) a housing defining a depth thereof and comprising a plurality of surfaces and several openings therethroughout, at least two of such plurality comprising informational material arranged relative to the several openings; and
b) a core member within the housing; and
c) a pair of wafers, each comprising a plurality of informational material, the wafers being positioned on either side of the core member therewithin the housing to permit viewing of such informational material through one or more of the openings, thereby permitting a collective reading of any one of the plurality of informational material thereon together with the informational material of the at least two of the plurality of surfaces of the housing, such collective reading providing an instructional lesson to the user.
